(19) United States
(12) Patent Application Publication
(10) Pub. No.: US 2011/0258129 A1
(43) Pub. Date: Oct. 20, 2011

(54) Post Approval Management System of Export Licenses

(75) Inventors: Rajiv Manucha, Toronto (CA); Steven Lloyd Crozier, Toronto (CA); Antonio Giuliano, Bolton (CA)

(73) Assignee: MANAGEMENT SYSTEMS RESOURCES, INC., Toronto (CA)

(21) Appl. No.: 12/760,067

(22) Filed: Apr. 14, 2010

(51) Int. Cl. G06Q 50/00; G06Q 10/00

(52) U.S. Cl. 705/317; 705/331

(57) ABSTRACT

A system and method for managing export licenses is disclosed. More particularly, but not by way of limitation, a system and method for managing creation of export license amendment forms relating to export and import of defense-related articles and services subject to regulations and regulatory agencies such as: United States Munitions List (USML), International Traffic in Arms Regulations (ITAR), Bureau of Industry and Security (BIS), and the Directorate of Defense Trade Controls (DDTC) are disclosed. Also, disclosed is a method and system for managing updates to authorizations and tracking of exported goods.

### FIELD OF THE DISCLOSURE

This disclosure relates generally to export license application creation and management of approved export authorizations. More particularly, but not by way of limitation, disclosed is a method, apparatus and system designed for the integrated post approval actions of maintaining export register records and providing an “amend form” function for export licenses.

### BACKGROUND

Bureau of Industry and Security (BIS) and the Directorate of Defense Trade Controls (DDTC) have implemented a mandatory electronic submission requirement for all types of export licenses. Application for licenses to DDTC or BIS may be a complex and time-consuming task. Also, International Traffic in Arms Regulations (ITAR) and Export Administration Regulations (EAR) require that information and material pertaining to defense and military related technologies is maintained subject to certain policies.

In many cases, difficulties may result from a lack of systematic controls over potentially complex licensing procedures. Companies, who operate without an integrated license management process, may expose themselves to the risk of consequences due to licensing errors. These consequences may be detrimental to a company.

Government departments have jointly issued various guidelines and manuals that articulate the requirements of a company's procedures and methodology. The guidelines include, for example, recommendation and requirements on organizational structure, corporate commitment and policy, identification, receipt and tracking of controlled goods, record keeping, internal monitoring, export and transfer, and training. These and other guidelines/requirements pertain to post approval and post receipt of licensed controlled goods.

Therefore, it has become increasingly important to convert the full license management process into electronic form. A comprehensive license management system that automates the export licensing process post approval management system and integrates the company's existing information technology (IT) infrastructure with the various Government agencies may enhance a business dealing in the import/export of controlled goods.

The quantity and values of an Export License, once approved, cannot be changed without amendment. Amendments must be submitted and approved for changes to an already approved authorization. The Dept. of State (DOS) has introduced at least three kinds of forms that allow companies to amend certain portions of previously approved licenses. The DOS provides a complex desktop “form filler” application that takes a user through approximately 30 different windows controls of the desktop application to produce an amendment. These form filler applications may take an inordinate amount of time to load and navigate and are error-prone.

Prior art systems have maintained the original license and each approved amendment separately. Therefore, in prior art systems, each time a request for shipment is processed the original license must have all approved amendments applied in order to reflect a current status. For example, to calculate a current authorization status (e.g., currently authorized quantity remaining to ship, currently approved destinations, etc.) the original license must be retrieved and each approved amendment chronologically applied to calculate a current value for each entry affected by an amendment.

Accordingly, it is desirable to improve the amendment process itself and ongoing monitoring operations relative to import/export licenses.

### SUMMARY

Disclosed are embodiments of a Post Approval Management System of Export Licenses (PAMSEL). In one embodiment, a comprehensive Export License management system designed to assist businesses with the assembly and maintenance of amendments and support documentation required for the export of US Munitions List (USML) and Commerce Control List (CCL) goods and technologies is disclosed. In another embodiment, the overall system is designed to help submit complete amendment packages to the appropriate licensing authorities, and then manage the post-approval tasks and responsibilities associated with the approved licenses and their corresponding amendments.

Also disclosed, is a method and system to amend information in a license, details of records, quantity and amount that can be exported etc. In one embodiment of this disclosure, a dynamic web-based application system to process amendments to previously approved licenses is detailed. The disclosed embodiment is dynamic because adding work windows to a displayed web page depends on the amendment type selected. In this embodiment, a user may start by selecting the license to amend from a dashboard style interface. The user may then select a type of amendment form and a type and subtype of amendment. Tailored work windows may then be presented as necessary to process the selection and amendment.

In another embodiment, once an authorization is active and in use, comprehensive tracking of associated export activity can be recorded and maintained as a Current License. The Current License reflects the original license and all approved amendments in a comprehensive fashion.

### BRIEF DESCRIPTION OF THE DRAWINGS

FIG. 1 shows a block diagram of Post Approval Management System of Export License (PAMSEL) and its interface to other systems according to one disclosed embodiment.

FIGS. 2A-C show, in flow chart form, potential decision steps taken by an Export Control Department (ECD) and/or a PAMSEL system when processing a user request for export or amendment.

FIG. 3 shows, in block diagram form, an example license table comprising a structure to maintain a Current License.

FIG. 4 shows, in block diagram form, an exemplary PAMSEL system architecture connected to end users.

FIG. 5 shows, in block diagram form, selected components of individual computer types from an exemplary PAMSEL system architecture.

### DETAILED DESCRIPTION

Disclosed are embodiments of a Post Approval Management System of Export Licenses (PAMSEL). In a PAMSEL system amendments may be linked to an original license. As a particular original license is amended through a formal amendment process, a logical representation of a Current License may be maintained. As used herein, a Current License refers to a license representation that has had all approved amendments (e.g., changes in allowed quantity) as of a point in time (usually current time) applied.

A PAMSEL environment may be designed to contain several operational components or subsystems. Those of ordinary skill in the art will recognize that any number of subsystems supporting a PAMSEL system may be provided and that division between subsystems or combination of subsystems may also be possible. Further, the system architecture disclosed herein is exemplary. Other system architectures may also be designed without departing from the scope of the systems and methods disclosed.

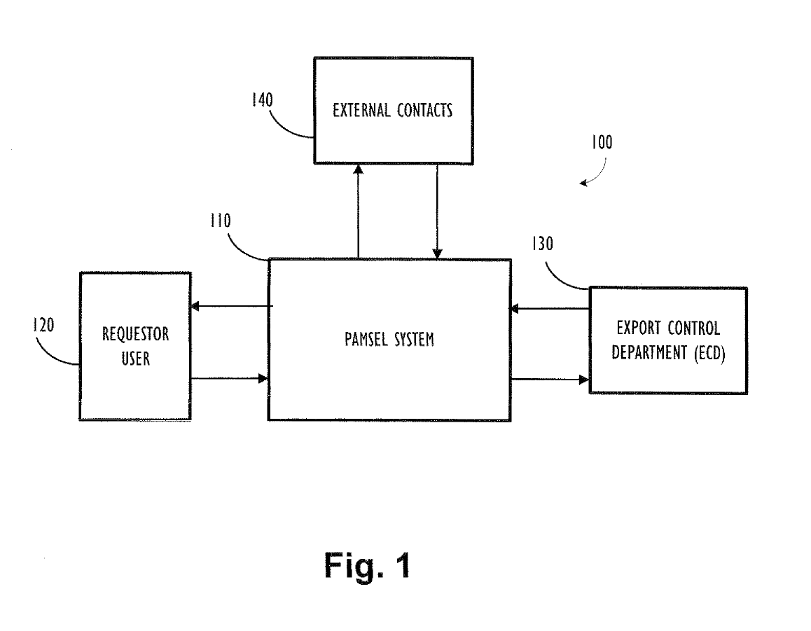

One example high level diagram is shown in FIG. 1. FIG. 1 shows, in block diagram form, one possible control flow 100 of data into and out of a PAMSEL system. Block 110 shows the PAMSEL system at the center of communications between requesting users 120 and a company's Export Control Department 130. Also, the PAMSEL system may be connected, via a network, to external contacts 140. External contacts 140 may include government agencies or other data information suppliers related to licenses and data maintained in a PAMSEL system.

Typically, a user request is made by a person within the company (“Requestor”) who initiates the export licensing process by creating and submitting export related requests to the company's Export Control Department for review. Support documentation can be attached to requests for assessment or for inclusion in the application package.

The PAMSEL system may further allow and assist a user to select and create various application types such as: (1) Department of State Applications (2) Department of State Agreement Applications (3) Department of Commerce Applications. The PAMSEL system can help in submitting an application that is fully compliant with the regulations. Obviously, compliant applications are more efficient and may avoid having an application rejected and sent back for non-compliance issues.

Approvals from the Directorate of Defense Trade Controls (DDTC) or the Bureau of Industry and Security (BIS) are required to resell, transfer or transship a defense good to any ultimate destination or end-user other than the one identified on the original authorization. Accordingly, the PAMSEL system may further provide for requesting approval for the reexport or retransfer of a defense article and also be used to seek approval for a change in ultimate destination, end-use or end-user.

Normally export and licensing decisions are made by the Export Control Department (ECD) of a business entity. The ECD can use a PAMSEL system to review and process new requests. Employees assigned to the ECD can also submit requests if necessary. Applications and exemptions can be created directly from a request, or the request can be applied to an existing authorization.

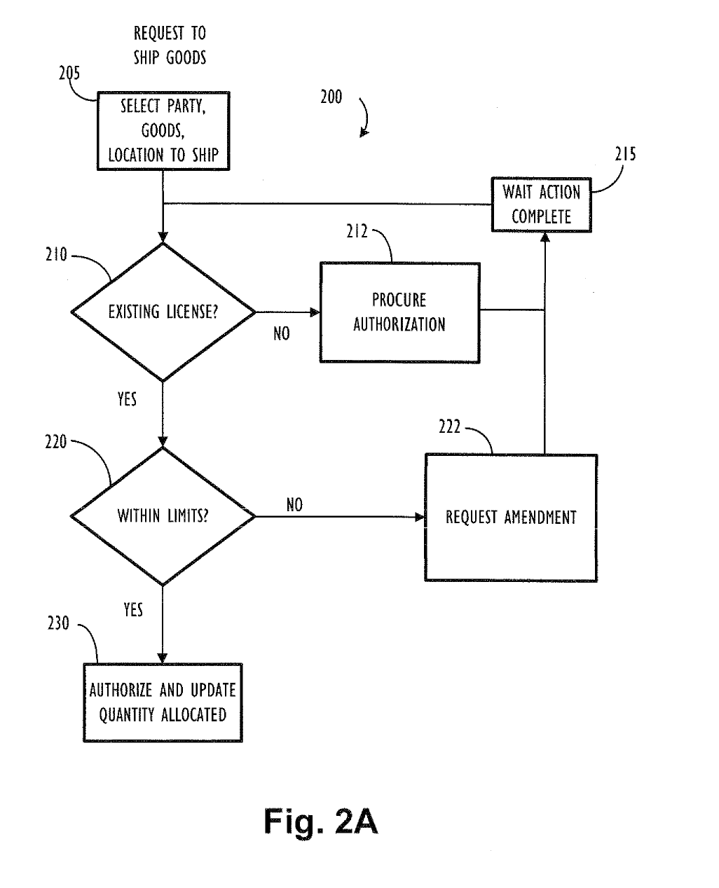

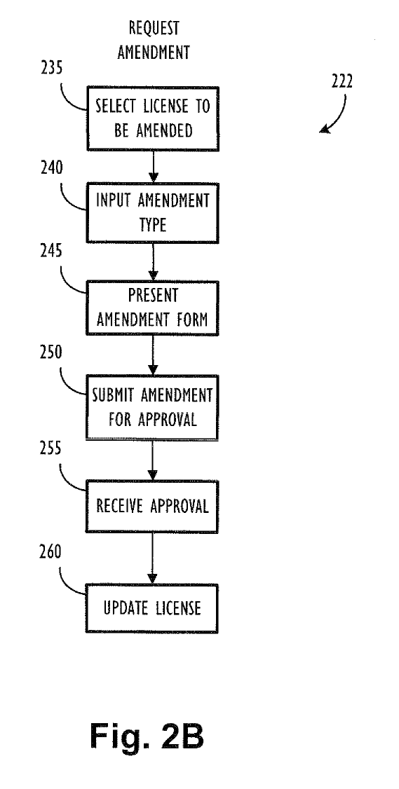

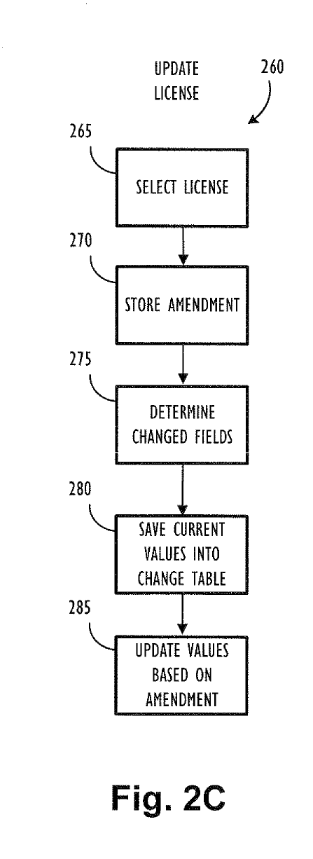

Referring now to FIGS. 2A-C, an embodiment of a request to ship goods is shown in flow chart 200 of FIG. 2A. Beginning at block 205 a user or another computer process identifies required attributes of a proposed shipment of goods, such as the parties, the goods, and involved locations. A check is made at 210 to determine if an existing license matches the supplied attributes. If there is no existing license (No prong 210), control flows to 212 to attempt to procure an authorization. If there is an existing license (YES prong 210), the attributes affecting authorization status are checked against a Current License to determine if the requested shipment's attributes are within the limits of the Current License at 220. If the attributes are not within current limits, control flows to 222 where an amendment may be requested. If the attributes are within current limits (YES prong 220), the shipment is authorized and the Current License's attributes are updated to reflect any changes based on this shipment. Prior to updating the attributes, the existing values are preferably stored to provide an audit trail. For example, the quantity allocated (i.e., authorized) by the Current License will be decremented by an amount equal to the amount approved for shipment. Note any time a request to procure authorization 212 or a request for amendment 222 is processed, a wait for action complete status is performed at block 215. Control may then automatically flow to block 210 again once the requested action is completed and approved.

Referring now to FIG. 2B, a request amendment process 222 is shown. When an amendment is requested a license must be identified and associated with the amendment as shown at block 235. In an interactive implementation of a PAMSEL system, a user can input a particular amendment type at block 240. Based on the type of amendment selected, amendment forms (i.e., data entry web pages) can be presented to an interactive user as reflected by block 245. Preferably only the fields that need to be changed can be presented, with any recurring fields filed in from the current license data. This approach simplifies user entry compared to the prior multi-page forms discussed previously. Next, at block 250, after all required data fields and amendment forms have been completed, the amendment can be submitted for approval. Block 245 represents a receipt of approval regarding the submitted amendment. Flow then continues to block 260 where a Current License can be updated as described next with reference to process flow 260.

Referring now to FIG. 2C, process flow 260 shows one example process to update a Current License after an amendment has been approved. At block 265, the license associated with the approved amendment is identified. Next at block 270, the actual approved amendment may be stored or archived in case the actual approved amendment may be required as part of an audit trail procedure. At block 275 all changed fields in the Current License corresponding to an approved amendment are identified and an updated value for each affected field is determined. At block 280, the current values prior to applying an amendment can be stored in a change table for compliance and/or audit trail reasons. Finally, at block 285 the Current License values are updated based on the determined new values reflecting the application of the approved amendment. In a preferred embodiment, the update is performed automatically so that the updated values will be updated efficiently and without human error (e.g., typographical errors).

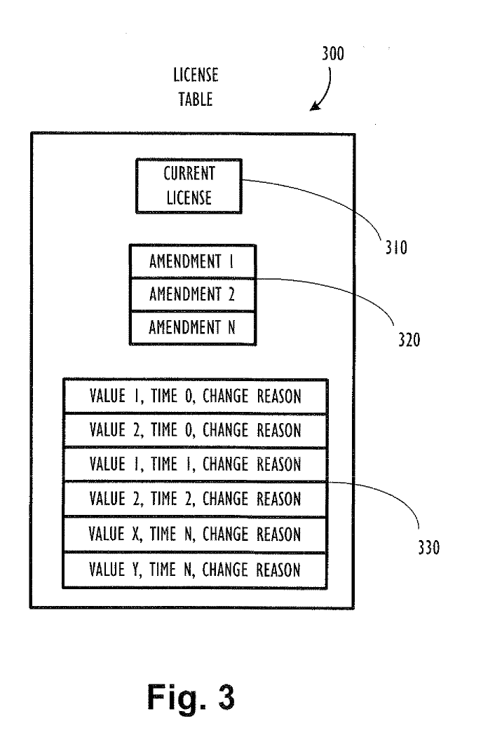

Referring now to FIG. 3, License Table 300 exemplifies an embodiment for maintaining amendments and change tables as discussed above. A Current License, as shown in element 310, is maintained with current values relative to all approved amendments or authorizations. Each amendment 1-N, as shown in element 320, can be stored and associated with a license to which the amendment applies. Change value section 330 can be used to reflect values as of any point in time. Generally, the changes are based on either amendments or shipment of items. Not all values will be changed in all amendments or shipments. That is, a single amendment or shipment may affect both values 1 and 2 or may only affect value 1. Also, not all affected values are numerical because a value may also reflect a list of countries authorized to receive shipments of goods associated with a particular license. Each entry preferably includes a change reason code, such as amendment or shipment, to provide further audit trail information. Further, while this description references a License Table 300 and describes it as one table, it is understood that this is a logical representation and various sections, such as amendments and change value, may be stored as separate records in separate tables and be linked to the current license through ID values.

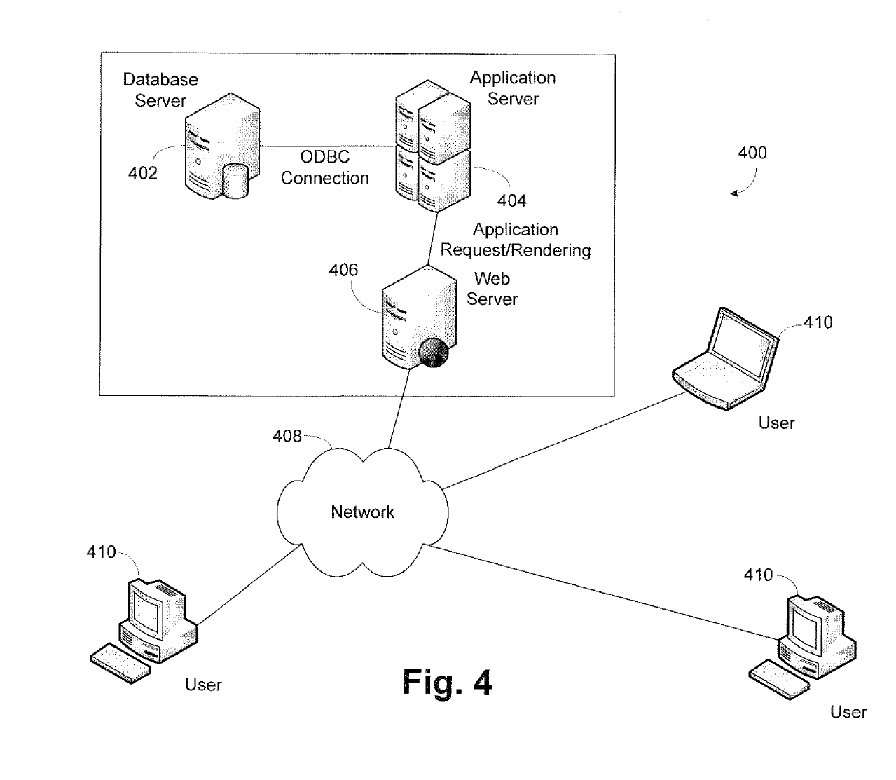

Referring now to FIG. 4, an example infrastructure implementation of a PAMSEL system 400 is shown. In a preferred embodiment, the PAMSEL system 400 may be implemented in a client-server, web based architecture and provided as an application service provider (ASP), software as a service (SaaS) model, or even hosted by a corporation using internal corporate infrastructure. Communication between computers depicted in FIG. 1 may be provided by any kind of computer network. The computer network may be either wired, wireless or a combination of both. Examples of computer networks include the Internet, an intranet, a local area network (LAN), a wide area network (WAN), or a combination of these and other network types.

The PAMSEL system 400 can be hosted on a server system consisting of one or more computers in communication with each other. Collectively the servers perform the functions of a database server 402, an application server 404 and a web server 406. Though illustrated as three separate computers, a greater or lesser number of computers can be utilized.

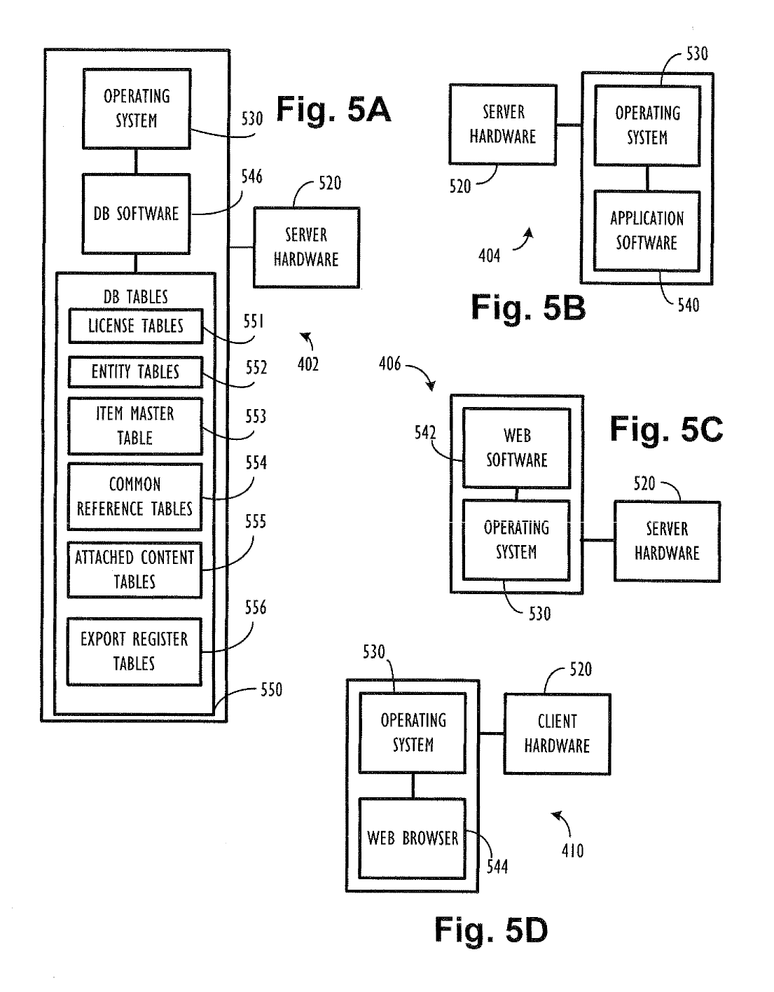

Continuing with FIG. 4 and referring now to FIGS. 5A-D, each server and client is configured on system hardware 520 and can carry out different logical portions of the overall functionality of PAMSEL 400 as indicated by the example name of the servers (e.g., database server 402, application server 404 and web server 406). Application server 404 receives requests from web server 406, processes them (with or without interaction with database server 402) and returns a result to web server 406. Requests are usually data manipulation requests and application server 404 interacts with database server 402 as necessary. Application server 404 may also process and format web pages prior to returning them to web server 406. In a preferred embodiment, application server 404 runs Windows 2003 server (available from Microsoft Corporation, Redmond, Wash.) as its operating system component 530. It is understood that this is exemplary and different operating systems 530 may also be used. Application server 404 also includes an open data base connectivity (ODBC) server to enable received ODBC compliant messages to be interpreted and executed by database server 402 and, additionally, to generate and transmit ODBC compliant messages. The Application server 404 generally performs the relevant steps of FIGS. 2A-C, such as 210, 220, 230, 245, 260 and all steps in FIG. 2C.

Web server 406 includes an operating system 530 and web server hosting software 542 capable of receiving Hyper Text Transfer Protocol (HTTP) requests, receiving data posted to Hyper Text Markup Language (HTML) or eXtensible Markup Language (XML) pages, interpreting received requests, retrieving requested web pages (e.g., HTML or XML pages), transmitting retrieved pages and transmitting other data through use of HTTP and other protocols. In the preferred embodiment web server hosting software 542 is provided using Microsoft IIS including the .NET framework (also available from Microsoft Corporation, Redmond, Wash.), though it is understood that other web environments can be used.

The database server 402 includes an operating system 530 and a database management system (DBMS) 546, which hosts the database 550. The Database Management System (DBMS) 546, in the preferred embodiment, is implemented using conventional SQL compliant relational database management (RDBMS) software such as those available from IBM of Armonk, N.Y.; Microsoft of Redmond, Wash.; Oracle of Redwood Shores Calif.; and the like. The DBMS 546 operates to create, maintain, update, query and otherwise control data stored in data tables, which form the database 550.

The PAMSEL 400 can be accessed by users with the appropriate security using: conventional workstation, hand-held, PDA and other devices, all illustrated as computers 410. In the preferred embodiment, the operating system 530 of devices 410 is a suitable version of Microsoft Windows, though other operating systems can be used. Computers 410 are in communication with server system hosting application and have client software such as a browser 544, i.e., Microsoft Internet Explorer in the preferred embodiment, though it is understood that other browsers such as Firefox from Mozilla Foundation and Safari from Apple Inc., Cupertino Calif. can be used. The client-side computers 410 have access to the PAMSEL application servers via a network 408 such as, the Internet, an intranet LAN or WAN connection or a combination thereof.

The computers 410 provide access to at least 2 basic categories of personnel within the firm using the software; Export Control Department users and Requestor users. These different categories of users can have different system access rights based on user profiles set up to allow secure access to functions required. For example, Export Control Department users can access both the export shipment request and amendment request functions while Requestor users can only access export shipment requests.

In this embodiment, database 550 contains tables that store data directly pertinent to the amendment process. These tables include one or more license tables 551, one or more entity tables 552, an item master table 553, one or more common reference tables 554, and one or more attached content Tables 555.

Database 550 contains tables that store data directly pertinent to a PAMSEL system. License tables 551 provide ability to store information relating to license applications (both in process and completed) and approved licenses. Specific tables carry specific types of information or levels of detail related to each license, as dictated by particular design choices. One example embodiment of a license table 551 is discussed above with reference to FIG. 3.

Entity tables 552 contain detailed records for a company's (supply chain partners) that an exporting company might deal with such as suppliers or customers. Information stored here includes name and address information, contacts, results of restricted party screening, etc. This is to enable lookup of accurate information about an entity when creating or editing license or amendment forms. Specific tables carry specific types of information or levels of detail related to each entity.

Item master table 553 contains detailed records for the parts and finished products involved in import and export transactions. This is to enable lookup of accurate information about an item when creating or editing license or amendment forms. Common reference tables 554 provide other pre-defined and validated lookup information such as units of measure, ports, states and provinces and system codes, to ensure that data used in license or amendment forms is accurate. Attached content tables 555 provide an ability to include or attach information (not defined by regular data fields) to license and amendment forms. Attached information may include other documents, document links, and free form text. Export register tables 556 store a register of exports against specific approved licenses.

In additional embodiments, database 550 can contain other data tables such as User Security Tables containing user rights and settings; and an event log table containing an audit trail of events that have been processed on the system, among others. Also, database 550 can contain other data tables such as an additional item tables containing more detailed item information, request tables used to store license requests and additional license information tables, among others.

Aspects of the embodiments are described as a method of control or manipulation of data, and may be implemented in one or a combination of hardware, firmware, and software. Embodiments may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative flow chart steps or process steps of FIGS. 2A-C may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 2A-C may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

We claim:

1. A method for operating a computer system to apply an amendment to an export license, the export license containing a plurality of fields having values, the method comprising:
the computer system retrieving the current values of the fields in the export license;
the computer system obtaining the fields of the export license to be changed by the amendment;
the computer system saving the current values of the fields to be changed by the amendment;
the computer system updating the values of the fields to be changed by the amendment; and
the computer system saving the updated values of the fields from the export license as the current values of the fields in the export license.

2. The method of claim 1, further comprising:
the computer system saving a copy of the amendment.

3. The method of claim 1, wherein the step of saving the current values of the fields to be changed by the amendment includes saving a change reason code indicating amendment with the values.

4. The method of claim 1, further comprising:
the computer system receiving an indication of a point in time; and
the computer system reconstructing current values of the fields as of the point in time by applying a reverse update of the saved current values of the fields to be changed by the amendment, applicable at the point in time, to the current values of the fields in the export license.

5. The method of claim 4, further comprising:
the computer system storing a change reason code indicating amendment with the values when saving the current values of the fields to be changed by the amendment; and
the computer system only applying fields associated with a particular set of one or more change reason codes as part of the reverse update.

6. A computer readable medium or media having computer-executable instructions stored thereon for operating a computer system to perform a method to apply an amendment to an export license, the export license containing a plurality of fields having values, the method comprising:
retrieving the current values of the fields in the export license;
obtaining the fields of the export license to be changed by the amendment;
saving the current values of the fields to be changed by the amendment;
updating the values of the fields to be changed by the amendment; and
saving the updated values of the fields from the export license as the current values of the fields in the export license.

7. The computer readable medium or media of claim 6, the method further comprising:
saving a copy of the amendment.

8. The computer readable medium or media of claim 6, wherein the step of saving the current values of the fields to be changed by the amendment includes saving a change reason code indicating amendment with the values.

9. The computer readable medium or media of claim 6, further comprising instructions to perform the method further comprising:
receiving an indication of a point in time; and
reconstructing current values of the fields as of the point in time by applying a reverse update of the saved current values of the fields to be changed by the amendment, applicable at the point in time, to the current values of the fields in the export license.

10. The computer readable medium or media of claim 6, further comprising instructions to perform the method further comprising:
storing a change reason code indicating amendment with the values when saving the current values of the fields to be changed by the amendment; and
applying only fields associated with a particular set of one or more change reason codes as part of the reverse update.

11. A computer system for applying amendments to an export license, the export license containing a plurality of fields having values, the computer system comprising:
an application server retrieving the current values of the fields in the export license;
the application server obtaining the fields of the export license to be changed by the amendment;
a database server coupled to the application server for saving the current values of the fields to be changed by the amendment;
updating the values of the fields to be changed by the amendment; and
the database server saving the updated values of the fields from the export license as the current values of the fields in the export license.

12. The computer system of claim 11, further comprising:
the database server storing a copy of the amendment.

13. The computer system of claim 11, wherein the step of saving the current values of the fields to be changed by the amendment includes saving a change reason code indicating amendment with the values.

14. The computer system of claim 11, further comprising:
the application server receiving an indication of a point in time; and
the application server reconstructing current values of the fields as of the point in time by applying a reverse update of the saved current values of the fields to be changed by the amendment, applicable at the point in time, to the current values of the fields in the export license.

15. The computer system of claim 11, further comprising:
the database server storing a change reason code indicating amendment with the values when saving the current values of the fields to be changed by the amendment; and
the application server applying only fields associated with a particular set of one or more change reason codes as part of the reverse update.

16. A method for operating a computer system to authorize shipments of goods against an export license, the export license containing a plurality of fields having values, the method comprising:
the computer system receiving values identifying the export license and attributes relating to a shipment of goods;
the computer system retrieving stored current values of the fields of the export license;
the computer system comparing the attributes relating to the shipment of goods and the related current values of the fields of the export license; and
if the comparison indicates the shipment of goods is within the limits of the export license, the computer system:
providing an authorization of the shipment of goods;
saving the current values of the fields of the export license;
updating the values of the fields of the export license based on the attributes of the shipment of goods; and
saving the updated values of the fields in the export license as the current values of the fields in the export license.

17. The method of claim 16, wherein the step of saving the current values of the fields of the export license includes saving a change reason code indicating shipment with the values.

18. A computer readable medium or media having computer-executable instructions stored thereon for operating a computer system to perform method for authorizing shipments of goods against an export license, the export license containing a plurality of fields having values, the method comprising:
receiving values identifying the export license and attributes relating to a shipment of goods;
retrieving stored current values of the fields of the export license;
comparing the attributes relating to the shipment of goods and the related current values of the fields of the export license; and
if the comparison indicates the shipment of goods is within the limits of the export license:
providing an authorization of the shipment of goods;
saving the current values of the fields of the export license;
updating the values of the fields of the export license based on the attributes of the shipment of goods; and
saving the updated values of the fields in the export license as the current values of the fields in the export license.

19. The computer readable medium or media of claim 18, wherein the step of saving the current values of the fields of the export license includes saving a change reason code indicating shipment with the values.

20. A computer system for authorizing shipments of goods against an export license, the export license containing a plurality of fields having values, the computer system comprising:
an application server; and
a database server coupled to the application server;
the application server receiving values identifying the export license and attributes relating to a shipment of goods;
the application server retrieving stored current values of the fields of the export license;
the application server comparing the attributes relating to the shipment of goods and the related current values of the fields of the export license; and
if the comparison indicates the shipment of goods is within the limits of the export license:
providing an authorization of the shipment of goods;
the database server saving the current values of the fields of the export license;
updating the values of the fields of the export license based on the attributes of the shipment of goods; and
saving the updated values of the fields in the export license as the current values of the fields in the export license.

21. The computer system of claim 20, wherein the step of saving the current values of the fields of the export license includes saving a change reason code indicating shipment with the values.
